(19) United States
(12) Patent Application Publication
(10) Pub. No.: US 2014/0303815 A1
(43) Pub. Date: Oct. 9, 2014

(54) METHOD FOR DETERMINING A TAXIING PATH OF AN AIRCRAFT OVER AN AIRPORT AREA

(71) Applicant: THALES, NEUILLY SUR SEINE (FR)

(72) Inventors: Stephanie LAFON, Merignac (FR); Francois Michel, Saint Medard En Jalles (FR)

(21) Appl. No.: 14/244,844

(22) Filed: Apr. 3, 2014

(30) Foreign Application Priority Data
Apr. 3, 2013 (FR) 1300754

(51) Int. Cl. G01C 21/34

(52) U.S. Cl. CPC G01C 21/3446
USPC 701/3

(57) ABSTRACT

The general field of the invention is that of methods for determining a taxiing path of an aircraft over an airport area. The method is implemented by the avionics system of the aircraft. It comprises the following steps:
Determining the “nodes” of a connectivity graph, said nodes representing the junction points between the traffic lanes of said airport area;
Determining the useful arcs joining said nodes and representing the network of traffic lanes that can be taken by the aircraft;
Attributing a “weight” to each useful arc;
Determining the optimal path by an algorithm of Dijkstra type starting from the present position of the aircraft up to its destination position and passing through datum points;
Computing, and displaying a graphical representation including a representation of the airport area, of the aircraft and of the optimal path.

The field of the invention is that of methods and systems embedded on an aircraft for assisting in the navigation and guidance of said aircraft in airport areas.

To enable pilots to taxi in complete safety and effectively over an airport area, air traffic controllers dedicated to this area communicate t the pilots taxiing directives to be complied with. Generally, this directive is provided to pilots by voice. This directive comprises the final destination, generally a stand for an arrival or a runway for a departure, a set of waypoints and possibly an intermediate stopping position. These directives are also called “clearances”.

Part of these directives can be sent over digital links or “datalink” to avoid saturation of the voice communications bandwidth and misinterpretation by pilots.

Once the directives are received, the pilots write them down on paper or, if the aeroplane is equipped with one, in a text input area known by the name of “scratchpad”. This input area is not used to process this information for the time being. Next, the pilots determine, by means of paper maps, the path that their aircraft must take. This procedure increases their workload. Moreover, it does not allow them to present the information optimally so as to have the best possible knowledge of the situation of the aircraft.

To avoid forgetting these directives, the latter can therefore be displayed on one of the display means present in the cockpit. They can also be recovered via digital data called CPDLC (Controller-Pilot Data Link Communications) messages or input manually by the pilot by way of physical or virtual keyboards or via a dedicated HMI. They are then conveyed to the avionics system for display and/or processing.

A first process consists in textually displaying the directives as they are given by the ATC (Air Traffic Control), i.e. the destination, the waypoints and if necessary an intermediate stopping position, and in indicating, preferably, only the elements that have yet to be traversed. However, displaying this information textually does not contribute any geographical location information.

A second process consists in presenting the information in the form of a path highlighting the waypoints and the destination on an electronic map of the airport. The aeroplane symbol is also placed on this path. Patent application US 2007;0299597 entitled “Method and device for assisting in the navigation of an airplane on the around at an airport” describes this type of means for displaying the path to be traversed by the aircraft over a map representing the airport.

To do this, the system requires, in addition to the taxiing directive, airport data containing information on the taxiing elements of the airport (types. geographical positions, shapes: names etc.). These elements are listed in so-called AMDB (Airport Mapping DataBase) databases, generally in the ARINC 816 format.

These bases do not always contain all the taxiing information required to realistically represent the path to be followed. For example, the guidelines painted on the taxiing elements or taxiways indicate to the pilots the path to follow. The position of these lines is filled in by the database providers based on aerial photos. However, when they take aerial shots of the airports, a certain number of aeroplanes are positioned on these lines and do not therefore allow a complete view of this network of guidelines. This problem of completeness of the databases is an obstacle to the computation and realistic representation of the path. Moreover, the AMDB bases have no information concerning the connectivity of the taxiing elements as a whole. This information is of paramount importance for enabling the computation of the path.

The reference patent FR 2 919 416 of the Applicant and entitled “Procédé de génération d'un graphe de connectivité d'éléments d'un aéronef pour l'aide au roulage et dispositifs associés” [Method for generating a connectivity graph of elements of an aircraft for taxiing assistance and associated devices] describes the generation of connectivity bases. Connectivity bases are composed of connectivity graphs representing the network of traffic lanes of the airport. These graphs contain the information needed to compute the path and display it. To form the graph of the logic connections between taxiing elements of the airport such as stands, aprons, taxiways, de-icing areas: runways etc., an analysis of the AMDB A816 database is launched to detect the common boundaries between all these traffic lanes. The nodes and the arcs of the connectivity graph make it possible to define the airport taxiing network. The nodes then represent waypoints and the arcs the links between all these waypoints.

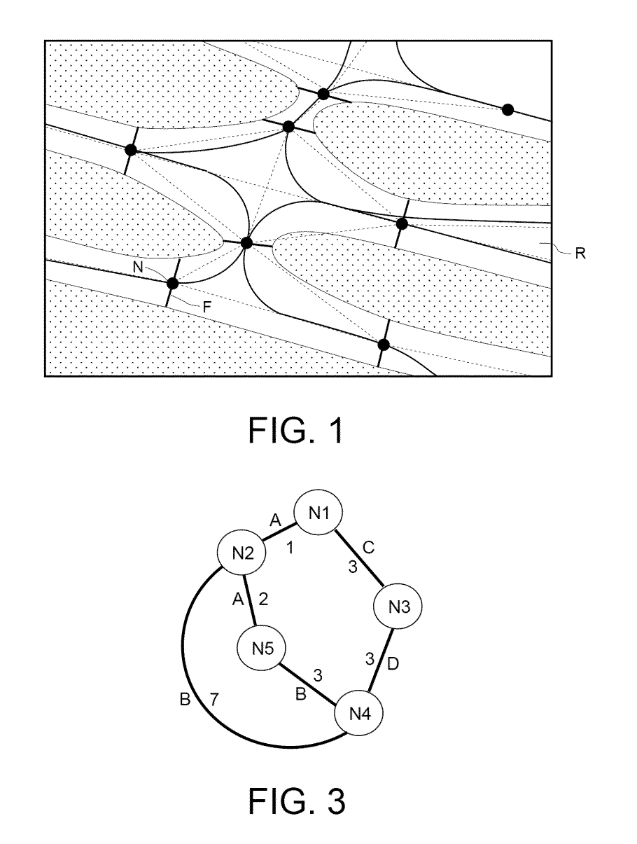

FIG. 1 illustrates this method. The traffic lanes R in the airport area are represented in white against a dotted background. The nodes N are represented by black circles and are situated in the centres of the boundaries between taxiing dements. These boundaries F are represented by straight segments in FIG. 1. By way of example, the information concerning the taxiing element such as the type of the lane, its name etc. can be situated at the level of the arcs and at the level of the nodes. However, this method does not solve the problem of database completeness.

The patent U.S. Pat. No. 7,343,229 entitled “Method and apparatus for dynamic taxi path selection” describes a method making it possible to take account, in establishing the taxiing path to be followed by the aircraft, of the aircraft parameters such as its speed, its weight, its wing span, and its turning circle, and also of the airport runway parameters. However, the latter document remains silent on the establishment of the best possible path to be followed by the aircraft.

The method of assisting in the navigation and guidance of aircraft in airport areas according to the invention does not have the previous drawbacks and makes it possible to determine a taxiing path that complies with the taxiing rules in effect and the operational constraints and which is also the optimal path allowing compliance with the taxiing directive given by the ATC. More precisely, the subject of the invention is a method for determining a taxiing path of an aircraft over an airport area passing through datum points, said method being implemented by the avionics system of said aircraft, said avionics system comprising a database of said airport area, computing means and displaying means, the method comprising the following steps:
Determining the “nodes” of a connectivity graph, said nodes representing the junction points between the traffic lanes of said airport area;
Determining the useful arcs joining said nodes and representing the network of traffic lanes that can be effectively taken by the aircraft, given the parameters of the database, the features of the aircraft and the temporary and local directives of said airport area;
Attributing a “weight” to each useful arc;
Determining the optimal path by an algorithm of Dijkstra type starting from the present position of the aircraft up to its destination position and passing through said datum points, the optimal path being composed of a sum of useful arcs with the lowest total weight;
Computing and displaying a graphical representation including at least one representation of the airport area, of the aircraft and of said optimal path.

Advantageously, the method includes an additional step of modifying the displayed path by means of a human-machine interface.

Advantageously, the “weight” of an arc is its geometrical length or its geometrical length weighted by a factor depending on the taxiing directives.

Advantageously, the features of the aircraft are its mass, its wingspan and its turning circle.

The invention also concerns an avionics system embedded on an aircraft, comprising at least a database of an airport area, computing means and displaying means, the computing means arranged in such a way as to determine a taxiing path of said aircraft over said airport area passing through datum points, characterized in that said computing means include:
Means for determining the “nodes” of a connectivity graph, said nodes representing the junction points between the traffic lanes of said airport area;
Means for determining the useful arcs joining said nodes and representing the network of traffic lanes that can be effectively taken by the aircraft, given the parameters of the database, the features of the aircraft and the temporary and local directives of said airport area;
Means for attributing a “weight” to each useful arc;
Means for determining the optimal path by an algorithm of Dijkstra type starting from the present position of the aircraft up to its destination position and passing through said datum points, the optimal path being composed of a sum of useful arcs with the lowest total weight;
Means for computing and displaying a graphical representation including at least one representation of the airport area, of the aircraft and of said optimal path.

The invention will be better understood and other advantages will become apparent upon reading the following description, in no way limiting, and with reference to the appended figures among which:

FIG. 1 already commented on, illustrates a method for determining taxiing paths according to the prior art;

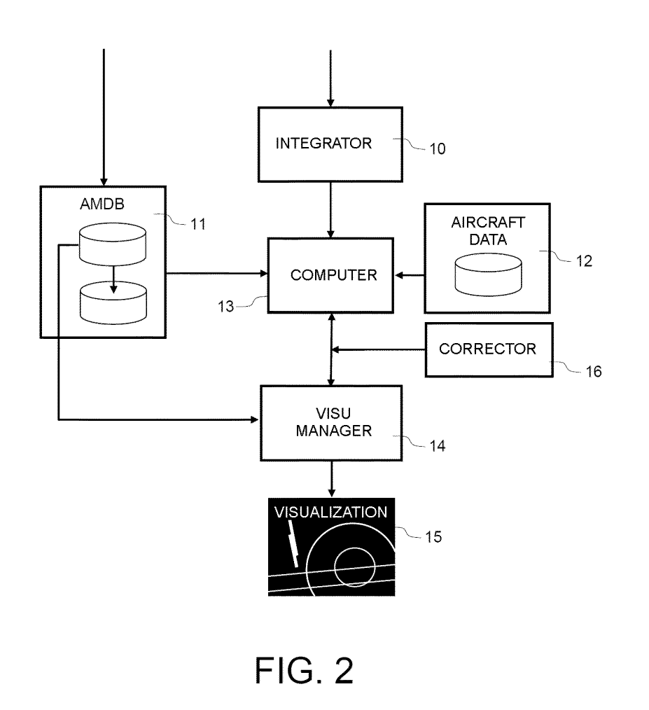

FIG. 2 represents the block diagram of an avionics system according to the invention;

FIG. 3 illustrates, with a simple example, the implementation of an algorithm of Dijkstra type in the context of the method according to the invention;

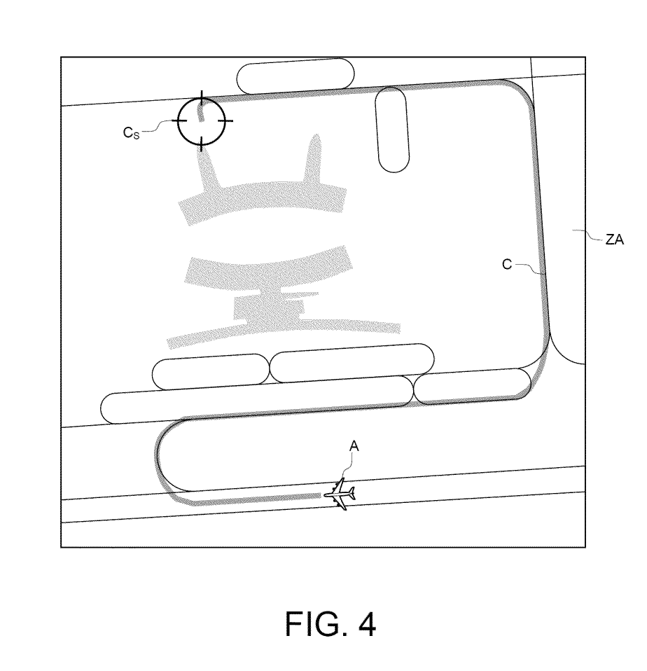

FIG. 4 represents an example of representation of the optimal path according to the invention in a visualization device.

FIG. 2 represents an avionics system suitable for implementing the method according to the invention. It is embedded on board an aircraft in the taxiing path in an airport area. In this FIG. 2, the arrows indicate the relationships existing between the various devices. The system includes the following devices:
An integrator 10 of external directives coming from the ATC. These directives can be integrated by the pilot by means of an input keyboard or by any other means such as voice recognition systems. The directives can also be integrated automatically if they are transmitted by “datalink”;
A database 11 called “AMDB”. generally in the ARINC 816 format and representing the airport area in which the aircraft is found. From this database, a computer establishes the connectivity graph representing said airport area;
An aircraft data manager 12 including the main features of the aircraft such as its mass, its dimensions, its wingspan, its turning circle and its maximum authorized taxiing speed;
A computer 13 of the optimal path, the function of which is to compute the optimal path by means of the data output by the directive integrator, the AMDB database and the aeroplane data manager. This computer is generally el dedicated function inside an embedded electronic computer;
A display manager 14 the function of which is to compute a graphical representation of the airport area and of the optimal path from the data output by the AMBD database and by the preceding computer;
A visualization screen 15 the function of which is to display the data output by the display manager. This is generally a colour matrix-type flat screen;
A path corrector 16 enabling the user to modify the path via an appropriate human-machine interface, so as to add additional constraints of passage not yet taken into account. This interface can be, by way of example, a touch-sensitive surface arranged on the preceding visualization screen or a graphical cursor device also called CCD (Cursor Control Device)

The method for assisting in the navigation and guidance of aircraft in airport areas according to the invention includes several steps that are detailed below.

A first step consists in establishing, from the data output by the AMDB ARiNC 816 database, a connectivity graph representing the traffic lanes of the airport area. This method has already been described in the reference patent FR 2 919 416 of the Applicant and will not be detailed in the present description. The first phase of this method is to determine the “nodes” of the connectivity graph, said nodes being representative of the junction points between the traffic lanes of the airport area.

The second step of the method consists in determining the useful arcs joining the preceding nodes and representing the network of the traffic lanes that can be effectively taken by the aircraft, given the parameters of the database, the features of the aircraft and the temporary and local directives of said airport area. This is an important difference from the method of the patent FR 2 919 416, which does not take account of the features of the craft. Indeed, in the method according to the invention, the arcs are only effectively created if the aeroplane can effectively take this portion of path. As a general rule, if a guideline exists that goes from one node to another, passage is authorized but these lines are not always filled in the AMDB A816 databases or do riot exist. In this case, the method determines, essentially at the level of the intersections, whether a path can be taken or not by the aircraft. As a function of the type and features of the craft, the method determines, essentially, as a function of the turning circle of the aircraft whether the latter can reach the next node without leaving the traffic lanes. Moreover, if a lane is temporarily closed or is not compatible with the type of aeroplane, which can be too wide, too heavy etc., the method indicates that the arcs representing these stumps, of road are not accessible. These arcs also have a taxiing direction attribute so as to allow compliance with no through road signs, temporary or otherwise. At the end of this step, all the nodes or arcs according to the implementation include all the information required to determine a viable taxiing path. By way of example, this information includes the names and the different types of taxiing elements, the categories of the retaining bars and the runways/taxiways that they protect, the lists of the stands, of the entrances to the parking areas etc.

The directives sent by the ATC generally concern a destination and waypoints. By way of example, the destination can be a retaining bar in front of a runway entrance designated by its name and category (CAT I,II,III), a stand, a parking area, an apron or a taxiway. In the latter case, the path stops before the intersection that leads to this taxiway.

These various items of information being filled in, the taxiing path to be computed therefore begins from a given initial position or, by default, from the current position of the aeroplane, and goes to the destination, passing through the waypoints specified by the ATC. This path, which complies with the taxiing regulations in effect and the operational constraints that are:
The path passes through all the waypoints and through the smallest possible number of off-directive elements;
The path does not include any backtracking unless the directive specifies it;
The path complies with the direction of circulation;
The chosen traffic lanes are compatible with the size of the aeroplane;
The size of the aeroplane is taken into account to determine the turning angles;
The path takes account of the current state of the traffic lanes which may be temporarily closed.

Moreover, the path must be optimal between the initial position and the final destination of the aircraft. The term “optimal” path is understood to mean the path that is both compliant with the preceding directives and also, while complying with these directives, the shortest possible path. Also, a “weight” is attributed to each arc. This weight generally represents the length of the arc. In this simple case, the optimal path is therefore the shortest, the one with the lowest weight.

In a last step, the optimal path is determined by an algorithm of Dijkstra type starting from the present position of the aircraft up to its destination position and passing through the datum points, the optimal path being composed of a sum of useful arcs, the total weight of which is the lowest.

The Dijkstra algorithm makes it possible to determine the shortest path in a connected graph. In this type of algorithm, all the connection points have the same role and may therefore be taken. The algorithm used in the method according to the invention is not quite a Dijkstra algorithm to the extent that a condition is imposed that certain waypoints will/will not be passed through. In the remainder of the description, this algorithm is said to be of Dijkstra “type”.

The algorithm of Dijkstra type requires only simple computing means to be implemented and operates in the following manner. It chooses a first node as close as possible to the aircraft. This node can be situated in front of the aircraft or behind in the event of return or “push back” to the stand, for example. The algorithm then formulates a table of taxiing elements Eₙ through which the path must pass, n representing the total number of elements of the airport area. Each row of this table corresponds to a waypoint Eᵢ predetermined by the ATC: each column to a node. The algorithm determines, by successive iterations and by knowledge of the arcs linking the nodes, column by column and row by row, the length of the path and the preceding nodes that correspond to the shortest path starting from the initial position and passing through all the elements {E₀, . . . , Eᵢ} of the directive. Each time a path is shorter and complies with the same constraints as another, the corresponding information at the level of the nodes is updated and is forwarded onto the following nodes.

FIG. 3 represents a simple case of application of the algorithm of Dijkstra type. In this example the airport area includes five nodes numbered N1 to N5; these nodes are interconnected by lanes denoted A, B, G and D. The length of the paths or the weight of the arcs linking two nodes is indicated in FIG. 3. It is indicated in arbitrary units. Thus, the length separating the node N1 from the node N2 has a value of 1 and the length separating the node N1 from the node N3 has a value of 3.

In the present case, the clearance received by the ATC is “Taxi to holding position N4 via A, B”, which means that the aircraft must go to the point N4 by taking the paths A and B. The closest node to the aeroplane is the node N1. The computation of the path therefore begins with this node. The path is represented by a matrix table. The rows of this table correspond to the successive waypoints of the clearance. Each node Ni has a column indicating whether paths exist starting from N1 arriving at Ni and passing through a certain number of waypoints. These paths are the shortest satisfying the operational constraints and complying with the size of the aeroplane. The algorithm then traverses all the nodes and updates the table row after row, as a function of the previous row. Each cell of the table then indicates the previous node of the path and its total weight. During this updating, the inaccessible nodes are considered as being at infinity and are represented in the tables by the conventional symbol ∞.

The tables numbered I, II, III and IV correspond to the successive updating of the initial table I. In each table, the pairs (n-Ni) correspond to (total path length—previous node).

TABLE I
Initial

| | N1 | N2 | N3 | N4 | N5 |
|---|---|---|---|---|---|
| | 0 | ∞ | ∞ | ∞ | ∞ |
| A | ∞ | ∞ | ∞ | ∞ | ∞ |
| A-B | ∞ | ∞ | ∞ | ∞ | ∞ |
| A-B-N4 | ∞ | ∞ | ∞ | ∞ | ∞ |

TABLE II
1^{st} updating

| | N1 | N2 | N3 | N4 | N5 |
|---|---|---|---|---|---|
| | 0 | ∞ | 3-N1 | ∞ | ∞ |
| A | ∞ | 1-N1 | ∞ | ∞ | ∞ |
| A-B | ∞ | ∞ | ∞ | ∞ | ∞ |
| A-B-N4 | ∞ | ∞ | ∞ | ∞ | ∞ |

TABLE III
2^{nd} updating

| | N1 | N2 | N3 | N4 | N5 |
|---|---|---|---|---|---|
| | 0 | ∞ | 3-N1 | 6-N3 | ∞ |
| A | ∞ | 1-N1 | ∞ | ∞ | 3-N2 |
| A-B | ∞ | ∞ | ∞ | ∞ | ∞ |
| A-B-N4 | ∞ | ∞ | ∞ | 8-N2 | ∞ |

TABLE IV
3rd updating

| | N1 | N2 | N3 | N4 | N5 |
|---|---|---|---|---|---|
| | 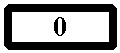 | ∞ | 3 − N1 | 6 − N3 | ∞ |
| A | ∞ | 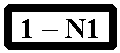 | ∞ | ∞ | 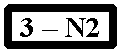 |
| A-B | ∞ | ∞ | ∞ | ∞ | ∞ |
| A-B-N4 | ∞ | ∞ | ∞ | 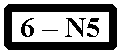 | ∞ |

At the end of the traversal, the algorithm backtracks up the inter-node links to construct the path. In this example the shortest path complying with the clearance is therefore: N1-N2-N5-N4. This path corresponds to the cells with bold outlines in Table IV. The length of the shortest path therefore has a value of 6.

In a last step, the method computes and displays a graphical representation including at least one representation of the airport area ZA, of the aircraft A and of said optimal path C on a visualization screen of the cockpit. Such a simplified representation is shown in FIG. 4.

The arcs defined in the connectivity graphs described previously are logic arcs that only indicate whether the aircraft can go from one taxiing element to another. The arcs cannot be used directly for the graphical representation of the path. Also, a specific graphical representation is associated with each arc or node according to the implementation. This graphical representation can be based on the guidelines associated with each arc if they are filled in the base. It can also be totally or partly composed of segments linking each node, the segments being replaced by curves in the case where the segments leave the taxiing areas. In this second case, a process of smoothing the angles and the series of segments is applied to improve the aesthetic appearance of the graphical rendition as can be seen in FIG. 4. This line gives an impression of highlighting of the route. It is also possible to represent the path to be followed in a different manner by using the elementary polygons of which it is composed. For example, the polygons of the path have a different colour or colours that are more saturated.

Adjustments can be made as a function of the operational requirements, such as a particular display for an arrival at a stand for example. It is then possible to choose to display the path only up to the entrance of the parking area and to indicate the destination stand, for example, by a target Cₛ drawn on the stand as seen in FIG. 4. Indeed, in the parking area, the control of the taxiing is done differently and it is therefore preferable to indicate only the entrance of the area and the location of the stand.

The pilots have the option to modify the path of the craft either graphically or textually by adding additional passage constraints. For example, if the modification is carried out by means of a graphical cursor, the method for modifying the taxiing path is done by clicking a first time on the part of the path that one desires to modify, then a second time on the part of the path through which one wishes to pass, the new path being automatically recomputed to take account of this change.

The method according to the invention thus makes it possible to guide pilots in real time in a graphical manner, by displaying indications of change of direction in a two-dimensional or three-dimensional graphical environment. It is also possible to provide this information regarding change of direction via the audio systems of the aircraft.

1. Method for determining a taxiing path of an aircraft over an airport area passing through datum points, said method being implemented by the avionics system of said aircraft, said avionics system comprising a database of said airport area, computing means and displaying means, the method comprising:
Determining the “nodes” of a connectivity graph, said nodes representing the junction points between the traffic lanes of said airport area;
Determining the useful arcs joining said nodes and representing the network of traffic lanes that can be effectively taken by the aircraft, given the parameters of the database, the features of the aircraft and the temporary and local directives of said airport area;
Attributing a “weight” to each useful arc;
Determining the optimal path by an algorithm of Dijkstra type starting from the present position of the aircraft up to its destination position and passing through said datum points, the optimal path being composed of a sum of useful arcs with the lowest total weight;
Computing and displaying a graphical representation including at least one representation of the airport area, of the aircraft and of said optimal path.

2. Method for determining a taxiing path according to claim 1, wherein the method includes an additional step of modifying the displayed path by means of a human-machine interface.

3. Method for determining a taxiing path according to claim 1, wherein the “weight” of an arc is its geometrical length.

4. Method for determining a taxiing path according to claim 3, wherein the “weight” of an arc is its geometrical length weighted by a factor depending on the taxiing directives.

5. Method for determining a taxiing path according to claim 1, wherein the features of the aircraft are its mass, its wingspan and its turning circle.

6. Avionics system embedded on an aircraft, comprising at least a database of an airport area, computing means and displaying means, the computing means arranged in such a way as to determine a taxiing path of said aircraft over said airport area passing through datum points, wherein said computing means include:
Means for determining the “nodes” of a connectivity graph, said nodes representing the junction points between the traffic lanes of said airport area;
Means for determining the useful arcs joining said nodes and representing the network of traffic lanes that can be effectively taken by the aircraft, given the parameters of the database, the features of the aircraft and the temporary and local directives of said airport area;
Means for attributing a “weight” to each useful arc ;
Means for determining the optimal path by an algorithm of Dijkstra type starting from the present position of the aircraft up to its destination position and passing through said datum points, the optimal path being composed of a sum of useful arcs with the lowest total weight;
Means for computing and displaying a graphical representation including at least one representation of the airport area, of the aircraft and of said optimal path.
